(19) United States
(12) Patent Application Publication
(10) Pub. No.: US 2017/0088749 A1
(43) Pub. Date: Mar. 30, 2017

(54) ADHESIVE MEMBER, METHOD FOR PRODUCING ADHESIVE MEMBER, AND METHOD FOR PRODUCING BONDED MEMBER

(71) Applicant: SHARP KABUSHIKI KAISHA, Osaka (JP)

(72) Inventor: Kenichiroh TSUCHIDA, Osaka (JP)

(73) Assignee: Sharp Kabushiki Kaisha, Osaka (JP)

(21) Appl. No.: 15/309,160

(22) PCT Filed: May 1, 2015
(86) PCT No.: PCT/JP2015/063077

§ 371 Date: Nov. 4, 2016

(30) Foreign Application Priority Data
May 9, 2014 (JP) 2014-097455

(51) Int. Cl. C09J 7/02; B32B 17/00; B32B 7/12; C09J 5/00; B32B 37/12

(52) U.S. Cl. CPC C09J 7/02; C09J 5/00; B32B 37/12; B32B 7/12; B32B 17/00; C09J 2201/32; C09J 2203/318; C09J 2205/10; B32B 2315/08; B32B 2457/202; G02F 1/1333

(57) ABSTRACT

An adhesive member for bonding a liquid crystal panel to a protective panel that has a window frame portion on a bonding surface includes an adhesive layer, and a pair of protective sheets respectively temporarily attached to both surfaces of the adhesive layer. One of the pair of protective sheets has a temporary attachment-side protrusion formed thereon having the same shape and height dimensions as the window frame portion formed on the bonding surface of the protective panel, and the adhesive layer is arranged between the pair of protective sheets so as to conform to the shape and height dimensions of the temporary attachment-side protrusion on the protective sheet.

### TECHNICAL FIELD

The present invention relates to an adhesive member, a method of manufacturing an adhesive member, and a method of manufacturing a bonded member.

### BACKGROUND ART

Conventional bonded members are formed by a pair of bonding objects being bonded together with an adhesive layer interposed therebetween. In a liquid crystal display device, for example, a protective panel for protecting a liquid crystal panel from external shocks or the like is bonded via an adhesive layer to the surface of a pair of glass substrates forming the liquid crystal panel, which is a display panel.

However, in order to form the window frame that decorates the display screen in this liquid crystal display device, printing is performed on the back surface of the protective panel, which could form protrusions thereon. In such a case, during attachment of the back surface of the protective panel to the liquid crystal panel surface with the adhesive layer interposed therebetween, the level difference (step) in the back surface of the protective panel caused by the protrusion could warp the attachment surface of the adhesive layer and allow air bubbles to enter the space between the protective panel and the adhesive layer. The air bubbles intruding in this manner risks degrading the display quality of the liquid crystal display device. As a countermeasure, Patent Document 1, for example, discloses a double-sided adhesive sheet for protective cover attachment that can fill the space between the display panel and the protective cover with an adhesive agent.

### RELATED ART DOCUMENT

### Patent Document

Patent Document 1: Japanese Patent Application Laid-Open Publication No. 2013-218118

### (Problems to be Solved by the Invention)

The double-sided adhesive sheet described in Patent Document 1 is constituted by a window frame made of a frame-shaped colored layer conforming to the window frame of the display screen, and an adhesive agent disposed on the window frame and in the window frame. Therefore, in the manufacturing process for the double-sided adhesive sheet, it is necessary to have separate materials and separate steps for forming the colored layer and adhesive agent, and this can complicate the manufacturing process of the double-sided adhesive sheet.

### SUMMARY OF THE INVENTION

The technology described in the present specification was made in view of the above-mentioned problems and aims at providing an adhesive member that is easy to make and used to manufacture a bonded member that inhibits the intrusion of air bubbles, a method of manufacturing this adhesive member, and a method of manufacturing a bonded member that uses this adhesive member.

### Means for Solving the Problems

A first technology described in the present specification relates to an adhesive member for bonding a pair of objects together, at least one of the objects having a protrusion formed on a bonding surface thereof, the adhesive member including: an adhesive layer; and a pair of temporary attachment members temporarily attached to both respective surfaces of the adhesive layer, wherein at least one of the pair of temporary attachment members has, on a surface thereof that is temporarily attached to the adhesive layer, a temporary attachment-side protrusion having a same shape and height as the protrusion formed on the bonding surface of the object, and wherein the adhesive layer is disposed between the pair of temporary attachment members so as to conform to the shape and height of the temporary attachment-side protrusion of the temporary attachment member. In the present specification, an adhesive agent having at least one of a temporary attachment-side member or a bonding object attached to one surface thereof is called an “adhesive layer.” Furthermore, in the present specification, the “same shape” is an error range including approximately the same shape, and the “same height dimensions” is an error range including approximately the same height dimensions.

In the adhesive member described above, due to the adhesive layer conforming to the shape and height dimensions of the temporary attachment-side protrusion of the temporary attachment member, a recess that has the same shape and depth dimensions as the temporary attachment-side protrusion is transcribed into the surface of the adhesive layer to which the temporary attachment member having this temporary attachment-side protrusion is temporarily attached. The temporary attachment-side protrusion has the same shape and height dimensions as the protrusion formed on the bonding surface of the bonding object, and thus the recess formed in the adhesive layer also has the same shape and depth dimensions as this protrusion. Therefore, removing the temporary attachment member from the surface of the adhesive layer where the recess is formed and fitting the protrusion on the bonding object into this recess in the adhesive layer attaches the bonding object having the protrusion formed on the bonding surface thereof to this surface of the adhesive layer, which makes it possible to attach the bonding object to the adhesive layer through conforming to the protrusion on the bonding object and also makes it possible, with respect to the bonding object having the protrusion formed on the bonding surface thereof, to inhibit the intrusion of air bubbles into the space between the bonding object and the adhesive layer.

Moreover, it is possible to manufacture the adhesive member described above by fabricating the temporary attachment member including the temporary attachment-side protrusion corresponding to the protrusion on the bonding object and attaching a pair of these temporary attachment members to both sides of the adhesive layer. Thus, the adhesive member can be manufactured in a simple process as compared to if the adhesive member were made of a plurality of components of differing materials with each having different steps, for example. As described above, the adhesive member can be manufactured in a simple process and then used to manufacture the bonded member, which inhibits the intrusion of air bubbles.

In the above-mentioned adhesive member, the adhesive layer may be disposed between the pair of temporary attachment members with no space between the adhesive layer and the pair of temporary attachment members.

With this configuration, the step surface of the step formed by the temporary attachment-side protrusion abuts the step surface of the step formed by the recess transcribed in the adhesive layer. Thus, after the temporary attachment member is removed from the surface of the adhesive layer where the recess is formed, the step surface of the step formed by the protrusion on the bonding object abuts the step surface of the step formed by the recess in the adhesive layer to make it possible to attach the bonding object having the protrusion formed on the bonding surface thereof to this surface of the adhesive layer, which makes it possible, with respect to the bonding object having the protrusion formed on the bonding surface thereof, to further inhibit the intrusion of air bubbles into the space between the bonding object and the adhesive layer.

In the above-mentioned adhesive member, each of the pair of attachment members may be a flexible sheet shape.

With this configuration, it is possible to make the temporary attachment member easier to remove from both surfaces of the adhesive layer as compared to if the pair of temporary attachment members were thick plate-like members, for example, and it is easy to manufacture the bonded member by using the adhesive member.

A second technology described in the present specification relates to a method of manufacturing the adhesive member described above, the method including: a temporary attachment member fabrication step of fabricating the pair of temporary attachment members, the at least one of the pair of temporary attachment members having, on the surface thereof to be temporarily attached to the adhesive layer, the temporary attachment-side protrusion; and an adhesive layer formation step including disposing an adhesive agent between the pair of temporary attachment members with the temporary attachment-side protrusion facing inward; and transcribing the temporary attachment-side protrusion in the adhesive agent to form a recess, thereby forming the adhesive layer to which the pair of temporary attachment members are temporarily attached.

With the method of manufacturing the adhesive member described above, in the temporary attachment member fabrication step, the temporary attachment member including the temporary attachment-side protrusion having the same shape and height dimensions as the protrusion formed on the bonding surface of the bonding object is fabricated. Then, in the adhesive layer formation step, the adhesive agent is disposed between the pair of temporary attachment members while the temporary attachment-side protrusion is facing inwards, and thereafter the adhesive agent is cured, thereby making it possible to form the recess having the transcribed temporary attachment-side protrusion in the adhesive layer while the pair of temporary attachment members are temporarily attached to the adhesive layer, and making it possible to manufacture the adhesive member having the adhesive layer conforming to the size and height dimensions of the temporary attachment-side protrusion between the pair of temporary attachment members. In this manner, in the method of manufacturing the adhesive member described above, the two steps, i.e., the temporary attachment member fabrication step and adhesive layer formation step, make it possible to easily manufacture the adhesive member. In the temporary attachment member fabrication step, the method of fabricating the temporary attachment member having the temporary attachment-side protrusion has no limitations.

A third technology described in the present specification relates to a method for manufacturing a bonded member by using the adhesive member, manufactured by the method of manufacturing the adhesive member described above so as to bond the pair of objects together with the adhesive layer interposed therebetween, the method including: a removing step of removing the temporary attachment member from a surface of the adhesive layer; a positioning step of positioning the adhesive layer from which the temporary attachment member has been removed relative to one of the objects along the surface of the adhesive layer from which the temporary attachment member has been removed; and a bonding step of bonding together the object and the adhesive layer from which the temporary attachment member has been removed, wherein, in the positioning step, the object is positioned relative to the adhesive layer from which the attachment member has been removed such that the protrusion on the object faces a recess when the recess is formed in the surface of the adhesive layer from which the temporary attachment member has been removed, and wherein, in the bonding step, when the recess is formed in the surface of the adhesive layer from which the temporary attachment member has been removed, the object is bonded to the adhesive layer with the protrusion on the object fitting into the recess.

In the method of manufacturing the bonded member described above, in the removing step, removing the temporary attachment member on which the protrusion is formed from the adhesive layer exposes the recess that the protrusion has transcribed in the removal surface of the adhesive layer. Then, in the positioning step, positioning the bonding object relative to the adhesive layer from which the temporary attachment member has been removed such that the protrusion and recess face each other causes the protrusion and recess to overlap in a plan view. Thus, in the bonding step, attaching the bonding object to the adhesive layer along a direction orthogonal to the removal surface of the adhesive layer makes it possible to attach both members by the protrusion fitting into the recess. This makes it possible to attach the bonding object to the adhesive layer while conforming to the protrusion of the bonding object, and makes it possible to manufacture a bonded member that inhibits the intrusion of air bubbles in the space between the bonding object and the adhesive layer.

### Effects of the Invention

The technology described in the present specification makes it possible to provide an adhesive member that is easy to make and used to manufacture a bonded member that inhibits the intrusion of air bubbles, a method of manufacturing this adhesive member, and a method of manufacturing a bonded member that uses this adhesive member.

### BRIEF DESCRIPTION OF THE DRAWINGS

FIG. 1 is a schematic cross-sectional view taken along the widthwise direction of a liquid crystal display device of Embodiment 1.

FIG. 2 is a schematic cross-sectional view of a bonded member of Embodiment 1.

FIG. 3 is a plan view of the liquid crystal display device.

FIG. 4 is a schematic cross-sectional view of an adhesive member of Embodiment 1.

FIG. 5 is a perspective view of an adhesive layer seen from the front.

FIG. 6 is a cross-sectional view showing a manufacturing step of the adhesive member.

FIG. 7 is a cross-sectional view showing a manufacturing step of the bonded member.

FIG. 8 is a cross-sectional view showing a manufacturing step of the bonded member.

FIG. 9 is a cross-sectional view showing a manufacturing step of the bonded member.

FIG. 10 is a schematic cross-sectional view of a bonded member of Embodiment 2.

FIG. 11 is a plan view of a liquid crystal panel.

FIG. 12 is a schematic cross-sectional view of an adhesive member of Embodiment 2.

FIG. 13 is a perspective view of an adhesive layer seen from the back.

FIG. 14 is a cross-sectional view showing a manufacturing step of an adhesive member.

FIG. 15 is a cross-sectional view showing a manufacturing step of the bonded member.

FIG. 16 is a cross-sectional view showing a manufacturing step of the bonded member.

FIG. 17 is a cross-sectional view showing a manufacturing step of the bonded member.

FIG. 18 is a schematic cross-sectional view taken along the widthwise direction of a liquid crystal display device of Embodiment 3.

FIG. 19 is a schematic cross-sectional view of an adhesive member of Embodiment 3.

FIG. 20 is a plan view of a touch panel.

FIG. 21 is a schematic cross-sectional view of the adhesive member of Embodiment 3.

FIG. 22 is a perspective view of an adhesive layer seen from the back.

### DETAILED DESCRIPTION OF EMBODIMENTS

### Embodiment 1

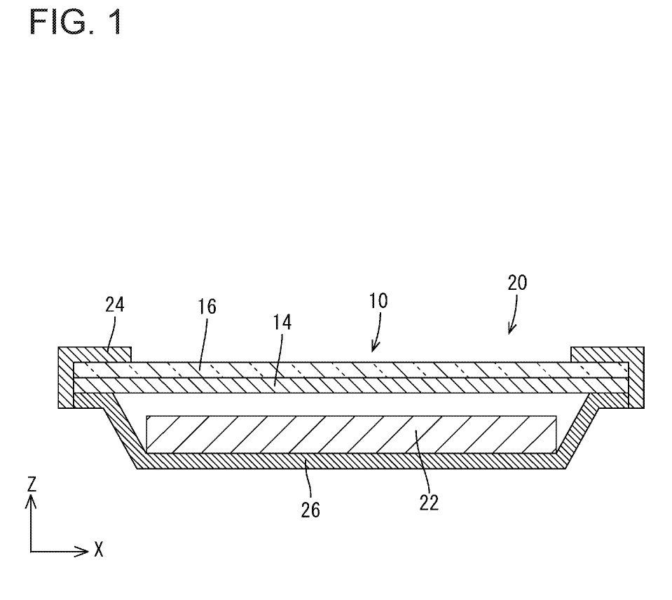

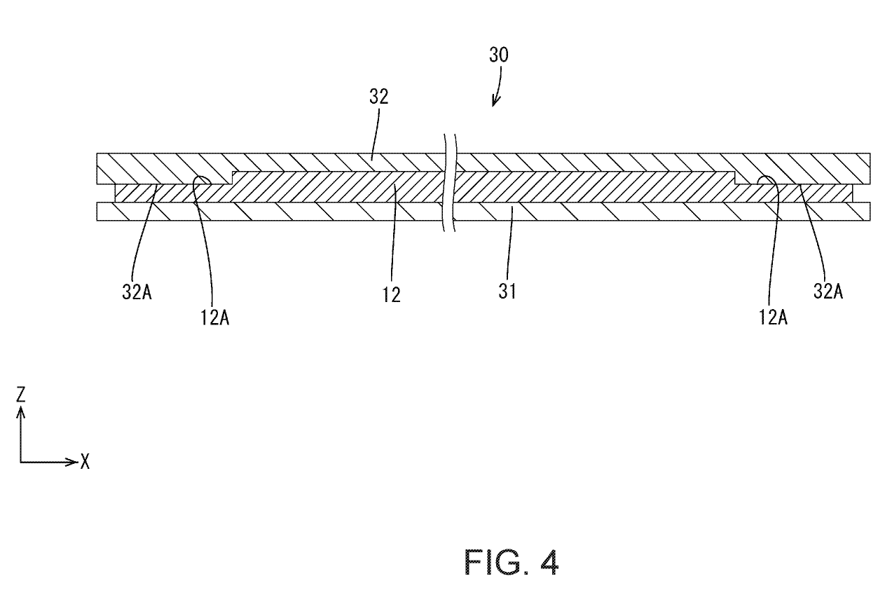

Embodiment 1 will be described with reference to FIGS. 1 to 9. In the present embodiment, a bonded member 10 in FIG. 1 and an adhesive member (see FIG. 4) 30 used for manufacturing this bonded member 10 are shown as examples. Each of the drawings indicates an X axis, a Y axis, and a Z axis in a portion of the drawings, and each of the axes indicates the same direction for the respective drawings. The up and down direction in the drawings is based on the up and down direction in FIG. 1, and the upper side in FIG. 1 is referred to as the front side while the lower side thereof is referred to as the rear side.

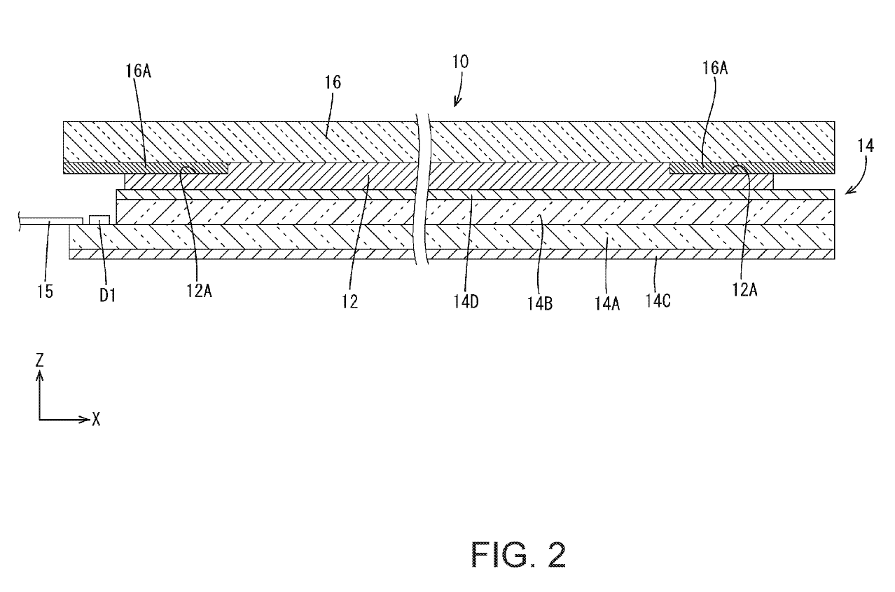

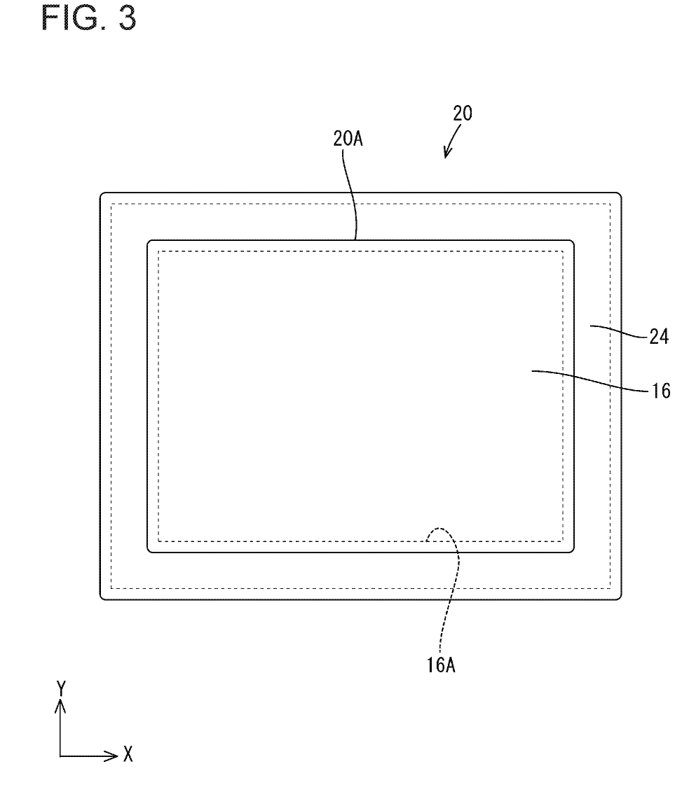

As in FIG. 2, the bonded member 10 illustratively shown in the present embodiment is constituted by a liquid crystal panel (one example of a bonding object) 14 being bonded via an adhesive layer 12 to a protective panel (one example of a bonding object) 16 that protects the display surface side (front side) of this liquid crystal panel 14, and the bonded member 10 forms a portion of a liquid crystal display device 20 shown in FIG. 1. As shown in FIG. 1, this liquid crystal display device 20 includes the bonded member 10 constituted by the liquid crystal panel 14 and the protective panel 16, and a backlight device 22 as a light source for emitting light towards the bonded member 10, with the liquid crystal display device displaying images on a flat rectangular display screen 20A (see FIG. 3). The liquid crystal display device 20 further includes a bezel 24 for holding the bonded member 10, and a case 26 to which the bezel 24 attaches and that houses the backlight device 22.

As shown in FIG. 2, the liquid crystal panel 14, which forms a portion of the bonded member 10, includes a pair of rectangular transparent (transmissive) glass substrates 14A and 14B, and a liquid crystal layer (not shown) having liquid crystal molecules therein interposed between the substrates 14A and 14B, with the substrates 14A and 14B being bonded together by a sealing agent (not shown) while maintaining a gap equivalent to the thickness of the liquid crystal layer. This liquid crystal panel 14 includes a display area where images are displayed and a substantially frame-shaped non-display area that surrounds the display area and where images are not displayed. Furthermore, as shown in FIG. 2, the outer surfaces of the substrates 14A and 14B have polarizing plates 14C and 14D attached thereto. Of the front and rear polarizing plates 14C and 14D, the adhesive layer 12 described above is provided on the outer surface of the polarizing plate 14D on the front side, or namely the surface of the polarizing plate 14D facing the protective panel 16. Hereinafter, the lengthwise direction (X-axis direction) of the liquid crystal display device 20 is the lengthwise direction of the respective components forming the bonded member 10, and the widthwise direction (Y-axis direction) of the liquid crystal display device 20 is the widthwise direction of the respective components forming the bonded member 10.

Of the two substrates 14A and 14B that form a portion of the liquid crystal panel 14, the substrate on the back side is the array substrate 14A and the substrate on the front side is the CF substrate 14B. The display area on the inner surface of the array substrate 14A (the surface facing the CF substrate 14B) forming a portion of the liquid crystal panel 14 has aligned thereon a large number of TFTs (thin film transistors) as switching devices and pixel electrodes connected to the TFTs, and a large number of gate wiring lines and source wiring lines surround these TFTs and pixel electrodes to form a grid shape. The gate wiring lines and the source wiring lines are connected to the respective gate electrodes and source electrodes, and the pixel electrodes are connected to the drain electrodes of the TFTs.

Meanwhile, the non-display area on the inner surface of the array substrate 14A has lead-out gate wiring lines and source wiring lines, and a driver D1 for liquid crystal driving connected to a terminal section where the terminals of these wiring lines are formed. The driver D1 is mounted on one end in the lengthwise direction of the array substrate 14A via a COG (chip on glass) method and can supply driving signals to both types of wiring lines connected thereto. One end of a flexible substrate 15 is crimp connected via an anisotropic conductive film to a position on the inner surface of the array substrate 14A adjacent to the driver D1. The other end of this flexible substrate 15 is connected to a control substrate (not shown), which makes it possible to send to the driver D1 image signals supplied by the control substrate.

The inner surface side of the CF substrate 14B (the surface facing the array substrate 14A) forming a portion of the liquid crystal panel 14 has aligned thereon a large number of color filters at locations overlapping the respective pixel electrodes of the array substrate 14A in a plan view. The color filters each have colored portions exhibiting R (red), G (green), and B (blue) in an alternating linear arrangement. A light-blocking member for preventing the mixing of colors is formed between the colored portions of the color filters. This CF substrate 14B has smaller lengthwise direction (X-axis direction) dimensions than the array substrate 14A and is bonded to the array substrate 14A such that one lengthwise end of the CF substrate 14B opposite to where the flexible substrate 15 is disposed aligns with the array substrate 14A. Alignment films for aligning the liquid crystal molecules included in the liquid crystal layer are respectively formed on the inner surfaces of the substrates 14A and 14B.

As shown in FIG. 2, while the CF substrate 14B is approximately equal in widthwise dimensions to the array substrate 14A, the lengthwise dimensions of the CF substrate 14B are smaller than the array substrate 14A, and the substrates are bonded together such that one lengthwise end (the top in FIG. 2) of the CF substrate 14B aligns with the array substrate 14A. Accordingly, over a prescribed range, the other end of the array substrate 14A in the lengthwise direction does not overlap the CF substrate 14B, but rather both front and back surfaces protrude outwards so as to secure a mounting area for the driver D1 and the flexible substrate 15 described above. Of the array substrates attached to the outer surfaces of the substrates 14A and 14B, the polarizing plate 14C on the back side of the liquid crystal panel 14 has a surface size that is approximately equal to the surface size of the array substrate 14A and is attached so as to cover approximately the entire back surface of the array substrate 14A. Meanwhile, the polarizing plate 14D positioned on the front side of the liquid crystal panel 14 has a surface size that is approximately equal to the surface size of the CF substrate 14B and is attached so as to cover approximately the entire front surface of the CF substrate 14B. The polarizing plate 14D attached to the front surface of the CF substrate 14B has the front surface thereof attached to the back surface of the adhesive layer 12.

The protective panel 16 forming a portion of the bonded member 10 is made of a rectangular substantially transparent glass substrate and has lengthwise dimensions and widthwise dimensions that are approximately equal to the array substrate 14A of the liquid crystal panel 14. As shown in FIG. 3, the frame-shaped region serving as the periphery of the front surface of the protective panel 16 is held by the bezel 24, and the area inside the frame-shaped region is exposed to outside of the liquid crystal display device 20 as the display screen 20A. The back surface of the protective panel 16 is attached to the front surface of the adhesive layer 12. As shown in FIG. 3, the frame-shaped region serving as the periphery of the back surface (one example of bonding surface) of the protective panel 16 has a frame-shaped window frame portion (one example of a protrusion) 16A. This window frame portion 16A decorates the display screen 10A of the liquid crystal display device 20 and is colored, with the inner edge of the window frame portion overlapping the outer edge of the display screen 10A. The window frame portion 16A is formed by printing on the back surface of the protective panel 16. As shown in FIG. 2, providing this type of window frame portion 16A on the back surface of the protective panel 16 forms protrusions that protrude towards the back surface (the side facing the adhesive layer 12) at the locations where the window frame portion 16A is provided on the back surface of the protective panel 16. The dimensions of the protruding of this window frame portion 16A are 10 μm to 60 μm, for example.

The adhesive layer 12 forming a portion of the bonded member 10 is a transparent photocurable adhesive agent that is sheet-shaped and adhesive on both the front and rear sides thereof. As shown in FIG. 2, the back surface of the adhesive layer 12 is attached to approximately the entire front surface of the liquid crystal panel 14 so as to include the display area of the liquid crystal panel 14, and the front surface of the adhesive layer 12 is attached to approximately the entire back surface of the protective panel 16 so as to include a portion of the window frame portion 16A of the protective panel 16. As shown in FIG. 2, the front surface of the adhesive layer 12 is arranged so as to conform to the shape and protruding dimensions (height dimensions) of the window frame portion 16A. Specifically, the location on the front surface of the adhesive layer 12 where the window frame portion 16A is attached has a recess 12A therein. This recess 12A is the same shape as the part of the window frame portion 16A attaching to the adhesive layer 12, and the depth dimensions of the recess 12A are equal to the height dimensions of the window frame portion 16A. Accordingly, in regard to the bonded member 10, the protective panel 16 on which the window frame portion 16A is formed attaches to the front surface of the adhesive layer 12 with the step surface of the step formed by the window frame portion 16A abutting the step surface of the step formed by the recess 12A.

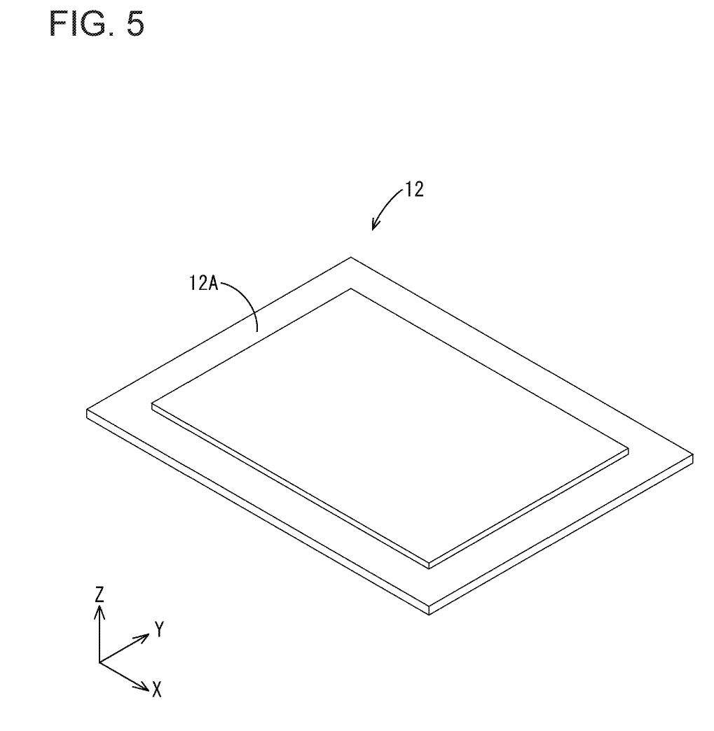

The configuration of the bonded member 10 was described above, and the adhesive member 30 used to manufacture this bonded member 10 will be described next. As shown in FIG. 4, the adhesive member 30 is constituted by a pair of flexible sheet-shaped protective sheets (one example of temporary attaching members) 31 and 32 that temporarily attach with the adhesive layer 12 interposed therebetween. The adhesive layer 12, which forms a portion of the bonded member 10, is the same as the adhesive layer 12 described above. Accordingly, this adhesive layer 12 has the recess 12A described above. As described above, the recess 12A in the adhesive layer 12 is the same shape as the part of the window frame portion 16A attached to the adhesive layer 12; thus, as shown in FIG. 5, the recess 12A in the adhesive layer 12 is arranged in a frame shape along the edge of the adhesive layer 12 on the front surface of the adhesive layer 12.

The pair of protective sheets 31 and 32 are rectangular in a plan view and made of PET (polyethylene terephthalate) films, for example. Of the pair of protective sheets 31 and 32, the protective sheet 31 positioned on the back side with the adhesive layer 12 interposed therebetween has a flat front surface and flat back surface. On the other hand, of the pair of protective sheets 31 and 32, the protective sheet 32 positioned on the front side with the adhesive layer 12 interposed therebetween has a temporary attachment-side protrusion 32A that protrudes towards the rear (towards the adhesive layer 12) at a location on the rear surface (one example of a temporarily attached surface) of the protective sheet 32 attached to the recess 12A in the adhesive layer 12. This temporary attachment-side protrusion 32A is the same shape as the window frame portion 16A and has the same height dimensions as the protruding dimensions (height dimensions) of the window frame portion 16A.

The adhesive layer 12 is disposed between the pair of protective sheets 31 and 32 so as to conform to the shape and size dimensions of the temporary attachment-side protrusion 32A formed on one of the protective sheets 32. Specifically, this protective sheet 32 (on the front side of the adhesive member 30) where the temporary attachment-side protrusion 32A is formed is attached to the front surface of the adhesive layer 12 such that the step surface of the step formed by the temporary attachment-side protrusion 32A abuts the step surface of the step formed by the recess 12A. Meanwhile, the other protective sheet 31 (on the back side of the adhesive member 30) with the surface temporarily attached to the adhesive layer 12 being a flat surface is attached to the entire rear surface of the adhesive layer 12, which is also a flat surface. The respective protective sheets 31 and 32 attaching to the adhesive layer 12 in this manner allows the adhesive layer 12 to be arranged between the protective sheets 31 and 32 with no gaps therebetween. The adhesive strength of the adhesive layer 12 to which the protective sheets 31 and 32 are attached is set such that the protective sheets 31 and 32 can be easily removed by an ordinary worker from the surfaces of the adhesive layer 12 to which the protective sheets are respectively attached.

The above was the configuration of the adhesive member 30, and next a method of manufacturing this adhesive member 30 will be described. First, a pair of flexible sheet-shaped pre-processed protective sheets each having both surfaces flat is prepared, and the temporary attachment-side protrusion 32A described above is formed on one of these pre-processed protective sheets (the sheet that will be positioned on the front side of the adhesive layer 12). The method of forming the temporary attachment-side protrusion 34A on this pre-processed protective sheet has no limitations. Furthermore, this protective sheet may alternatively already have the temporary attachment-side protrusion 34A pre-formed thereon. In the present embodiment, the other protective sheet (the sheet that will be positioned on the back side of the adhesive layer 12) does not have the temporary attachment-side protrusion 32A formed thereon, and thus can be used as-is without processing or the like due to both surfaces already being flat. The above fabricates the pair of protective sheets 31 and 32 forming a portion of the adhesive member 30 (one example of a temporary attachment member fabrication step).

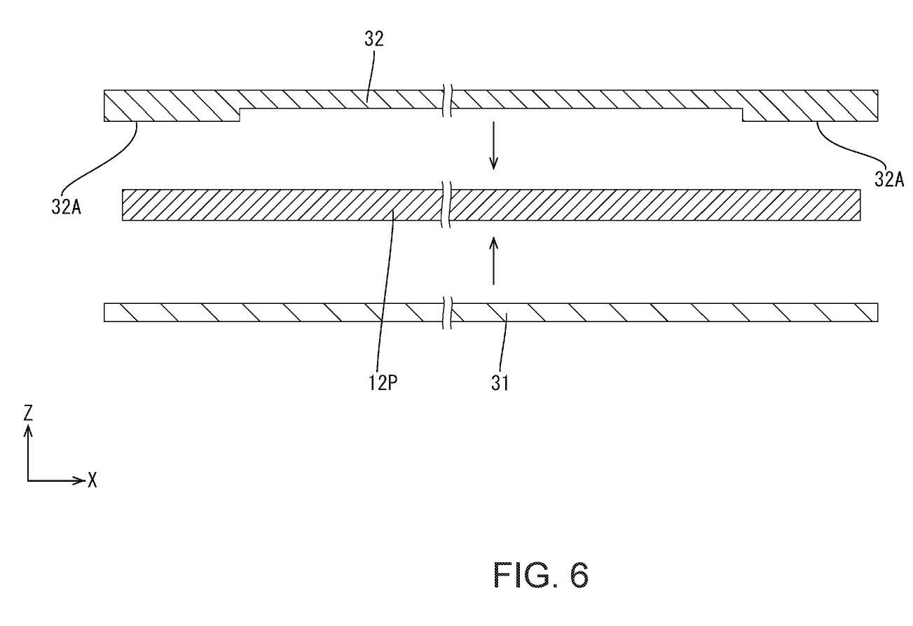

Next, an adhesive agent 12P in gel form pre-photocuring having flat surfaces where the respective protective sheets 31 and 32 will temporarily attach is prepared. Then, as shown in FIG. 6, while the temporary attachment-side protrusion 32A of the protective sheet 32 faces inward (faces the adhesive agent 12P), the adhesive agent 12P is arranged between the pair of protective sheets 31 and 32 and pressure is applied while this adhesive agent 12P is interposed between the pair of protective sheets 31 and 32. This transcribes the temporary attachment-side protrusion 32A onto the location of the adhesive agent 12P facing the temporary attachment-side protrusion 32A and forms the recess 12A. In other words, pressing the temporary attachment-side protrusion 32A onto the location of the adhesive agent 12P facing the temporary attachment-side protrusion 32A forms a recess 12A in this location that has the same shape as the temporary attachment-side protrusion 32A and also the same height dimensions and depth dimensions as the temporary attachment-side protrusion 32A.

Furthermore, applying pressure with the adhesive agent 12P interposed between the pair of protective sheets 31 and 32 temporarily attaches the respective protective sheets 31 and 32 to the adhesive agent 12P. Thereafter, the adhesive agent 12P is photocured and the adhesive layer 12, which constitutes a portion of the adhesive member 30, is formed while maintaining the shape and depth dimensions of the recess 12A in the adhesive agent 12P (one example of an adhesive layer formation step). The above process completes the adhesive member 30 shown in FIG. 5.

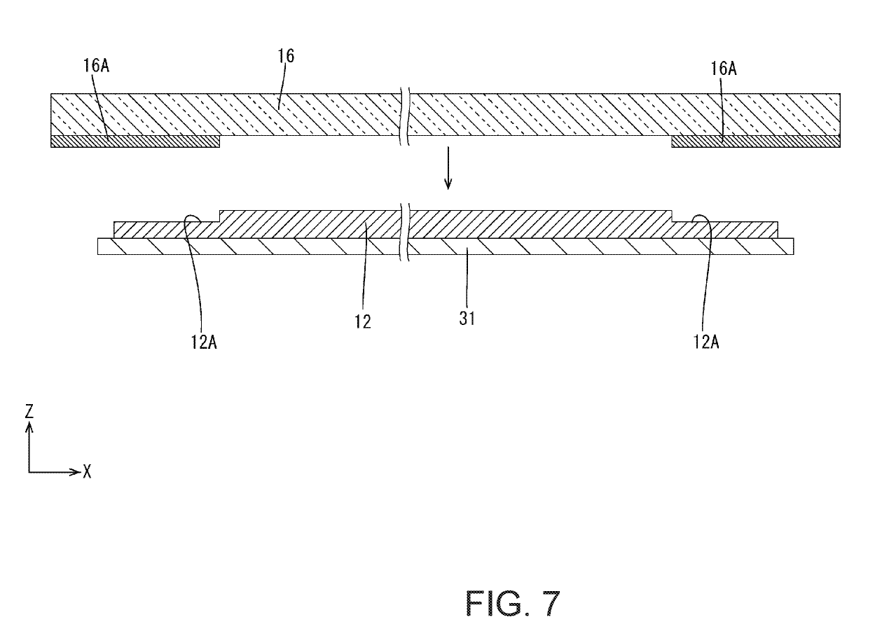

Next, a method of manufacturing the bonded member 10 described above using this adhesive member 30 will be described. First, the adhesive member 30 is prepared, and one of the protective sheets 32 (the protective sheet 32 having the temporary attachment-side protrusion 32A) is removed from the front surface of the adhesive layer 12 (one example of a removing step). As shown in FIG. 7, this exposes the recess 12A where the temporary attachment-side protrusion 32A was transcribed at the front surface of the adhesive layer 12 from which the protective sheet 32 has been removed (hereinafter, “removal surface”). Next, as shown in FIG. 7, the adhesive layer 12 from which the protective sheet 32 has been removed and the protective panel 16 described above are positioned along the removal surface, or namely, the X-Y planar direction (one example of a positioning step). Specifically, while the side of the protective panel 16 where the window frame portion 16A is disposed is facing the removal surface of the adhesive layer 12, the adhesive layer 12 from which the protective sheet 32 was removed is positioned relative to the protective panel 16 such that the window frame portion 16A and the recess 12A face each other (see FIG. 7). This causes the window frame portion 16A and the recess 12A to overlap in a plan view.

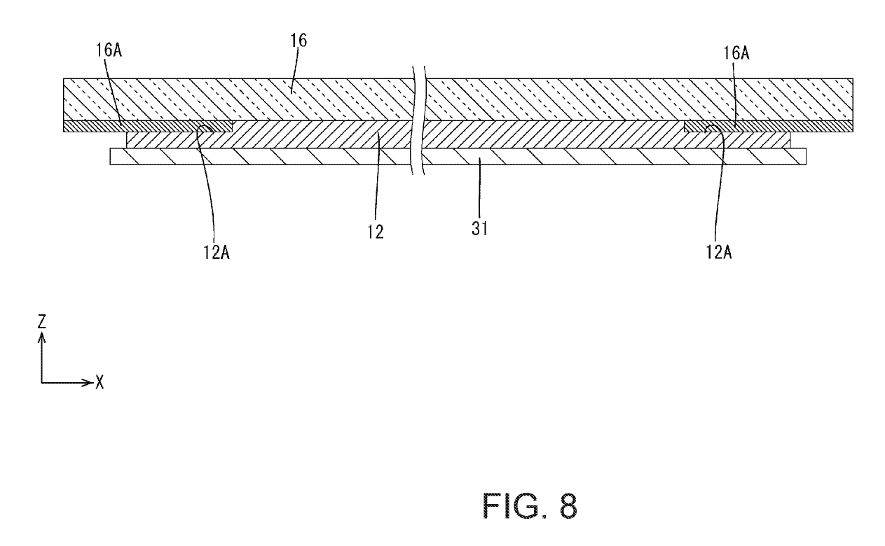

Next, as shown in FIG. 8, the positioned protective panel 16 and adhesive layer 12 from which the protective sheet 32 has been removed are bonded together (one example of a bonding step). Specifically, the protective panel 16 and the adhesive layer 12 are bonded together such that the window frame portion 16A of the protective panel 16 fits into the recess 12A in the adhesive layer 12. This positioning causes the window frame portion 16A and the recess 12A to overlap in a plan view as described above, and thus it is possible to bond the protective panel 16 and the adhesive layer 12 together by the window frame portion 16A fitting into the recess 12A in this manner. This makes it possible to attach the protective panel 16 to the removal surface of the adhesive layer 12 in a way that conforms to the window frame portion 16A. In other words, the step surface of the step formed by the window frame portion 16A abutting the step surface of the step formed by the recess 12A allows the protective panel 16 on which the window frame portion 16A is formed to be attached to the front surface of the adhesive layer 12 with no gaps therebetween.

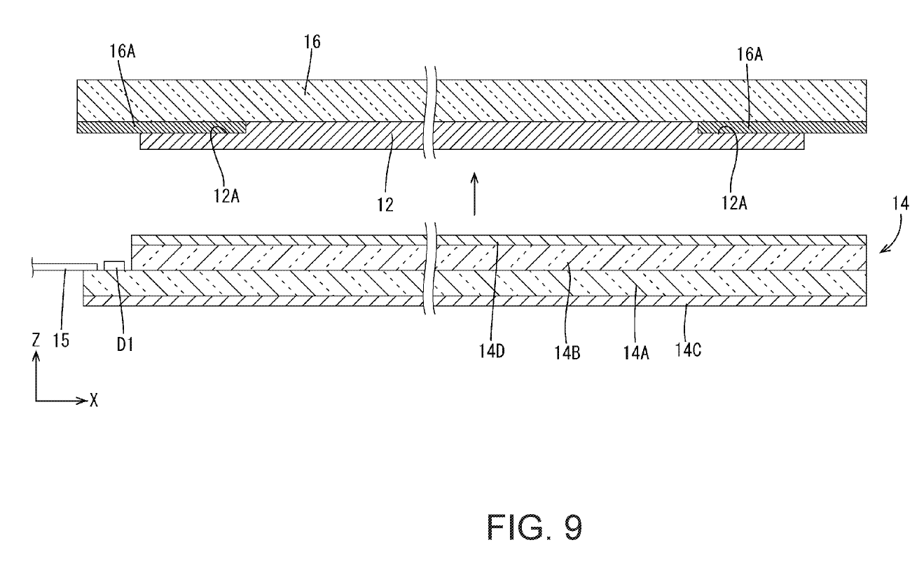

Next, as shown in FIG. 9, the other protective sheet 31 (the protective sheet 31 that does not have the temporary attachment-side protrusion 32A) is removed from the back surface of the adhesive layer 12 (one example of a removing step). This exposes the back surface of the adhesive layer 12, which is a flat surface. Next, as shown in FIG. 9, the adhesive layer 12 from which the other protective sheet 31 has been removed and the liquid crystal panel 14 described above are positioned along the removal surface, or namely, the X-Y planar direction (one example of a positioning step). Specifically, alignment marks or the like are formed on the liquid crystal panel 14 beforehand, and while the polarizing plate 14D attached to the side of the liquid crystal panel 14 nearer to the CF substrate 14B is facing the removal surface, the adhesive layer 12 from which the other protective sheet 31 has been removed is positioned relative to the liquid crystal panel 14.

Next, the positioned liquid crystal panel 14 and adhesive layer 12 from which the other protective sheet 31 has been removed are bonded together (one example of a bonding step). In other words, the front surface of the liquid crystal panel 14, which is a flat surface, and the removal surface of the adhesive layer 12, which is also a flat surface, are bonded to each other. The above process completes the bonded member 10 shown in FIG. 2.

In the embodiment described above, the bonded member 10 is manufactured using the adhesive member 30, which includes the adhesive layer 12 with the recess 12A that is the same shape and depth as the window frame portion 16A of the protective panel 16 formed therein, and this makes it possible for the protective panel 16 to be attached to the adhesive layer 12 by conforming to the window frame portion 16A of the protective panel 16. Due to this, for a protective panel 16 having a window frame portion 16A such as in the present embodiment, it is possible to inhibit the intrusion of air bubbles into the space between the protective panel 16 and the adhesive layer 12. Furthermore, as described above, the liquid crystal panel 14 is bonded with a flat surface thereof bonded to the flat surface of the adhesive layer 12, and thus warping is unlikely to occur between these two members. Inhibiting the intrusion of air bubbles into the space between the protective panel 16 and the adhesive layer 12 and suppressing warping between the liquid crystal panel 14 and the adhesive layer 12 in this manner makes it possible to achieve favorable display quality in the liquid crystal display device 20, which includes the bonded member 10 constituted by the liquid crystal panel 14 and the protective panel 16 having the window frame portion 16A being bonded together with the adhesive layer 12 interposed therebetween.

Furthermore, the adhesive member 30 of the present embodiment used for manufacturing the bonded member 10 is itself easy to manufacture due to two steps: the step of fabricating the protective sheet 32 having the temporary attachment-side protrusion 32A conforming to the window frame portion 16A of the protective panel 16, and the step of attaching the pair of protective sheets 31 and 32 to both surfaces of the adhesive layer 12. Thus, the adhesive member 30 of the present embodiment can be manufactured in a simple process as compared to if the adhesive member were made of a plurality of components of differing materials with each having different steps, for example. As described above, the adhesive member 30 of the present embodiment can be manufactured in a simple process and then used to manufacture the bonded member 10, which inhibits the intrusion of air bubbles.

Moreover, as described above, in the present embodiment the adhesive layer 12 of the adhesive member 30 is disposed between the protective sheets 31 and 32 with no gaps therebetween, and the step surface of the step formed by the temporary attachment-side protrusion 32A abuts the step surface of the step formed by the recess 12A transcribed by the adhesive layer 12. Therefore, after the protective sheet 32 is removed from the surface of the adhesive layer 12 where the recess is formed 12A, the step surface of the step formed by the window frame portion 16A of the protective panel 16 abuts the step surface of the step formed by the recess 12A in the adhesive layer 12 to make it possible to attach the protective panel 16 where the window frame portion 16A is formed on the bonding surface to this surface, which makes it possible, with respect to the protective panel 16 where the window frame portion 16A is formed on the bonding surface, to further inhibit the intrusion of air bubbles into the space between the protective panel 16 and the adhesive layer 12.

In the present embodiment, in the adhesive member 30, each of the pair of protective sheets 31 and 32 is flexible and sheet-shaped. Thus, it is possible to make the protective sheets 31 and 32 easier to remove from both surfaces of the adhesive layer 30 as compared to if the pair of protective sheets were thick plate-like members, for example, and it is easy to manufacture the bonded member 10 by using the adhesive member 30 of the present embodiment.

### Embodiment 2

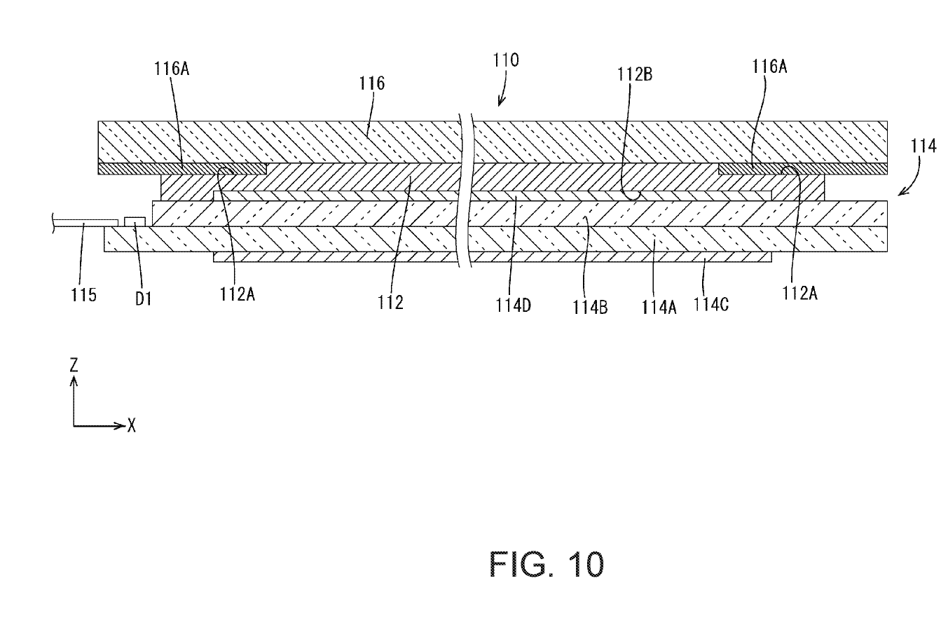

Embodiment 2 will be described with reference to FIGS. 10 to 17. As illustratively shown in FIG. 10, a bonded member 110 has polarizing plates 114C and 114D respectively positioned on the front and back of the liquid crystal panel 114 that are slightly smaller than in Embodiment 1. Therefore, as shown in FIG. 10, the polarizing plate (one example of a protrusion) 114D positioned on the front side of the liquid crystal panel 114 has the entire surface thereof except for the surface attached to a CF substrate 114B of the liquid crystal panel 114 covered by an adhesive layer 112. The back surface of the adhesive layer 112 forming a portion of the bonded member 110 is arranged so as to conform to the shape and height dimensions (thickness dimensions) of the polarizing plate 114D. Specifically, a second recess 112B is provided in a location on the back surface of the adhesive layer 112 where the polarizing plate 114D is attached. This second recess 112B is the same shape as the location of the polarizing plate 114D attached to the adhesive layer 112 and has the same depth dimensions as the height dimensions of the polarizing plate 114D. Accordingly, in the bonded member 110 of the present embodiment, the front surface of the liquid crystal panel 116 attaches to the rear surface of the adhesive layer 112 such that the step surface of the step formed by the polarizing plate 114D abuts the step surface of the step formed by the second recess 112B.

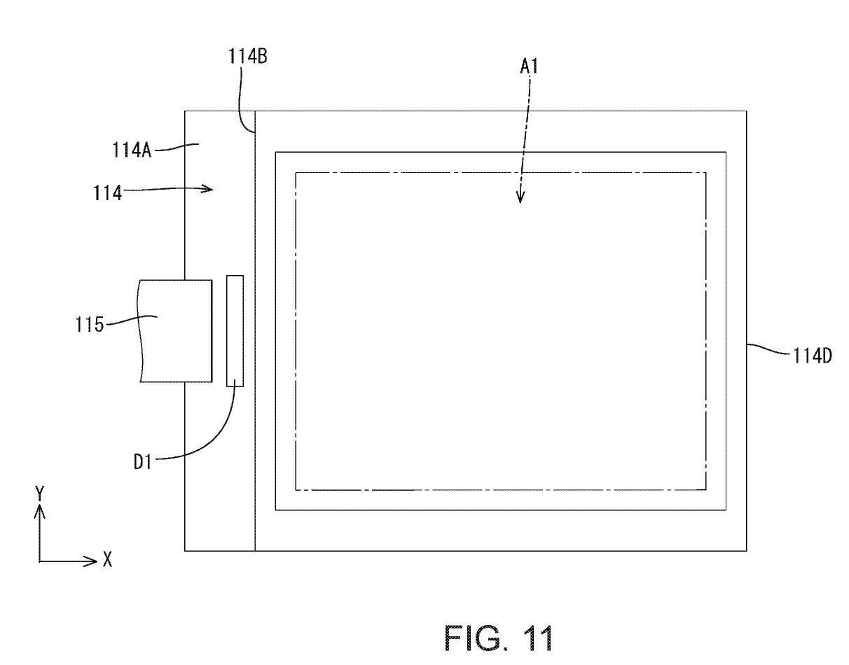

In the present embodiment, the other configurations of the bonded member 110 are the same as Embodiment 1, and thus an explanation of the structure, workings, and effects thereof will be omitted. In FIGS. 10, 12, and 14 to 17, the respective reference characters in FIGS. 2, 4, and 6 to 9 with 100 added thereto are the same components described in Embodiment 1. As shown in FIG. 11, the polarizing plate 114D positioned on the front side of liquid crystal panel 114 includes the entire display area Al where images are displayed therein in a plan view; thus, as above, the liquid crystal display device of the present embodiment can have images displayed on the display screen of the liquid crystal display device via the polarizing plate 114D.

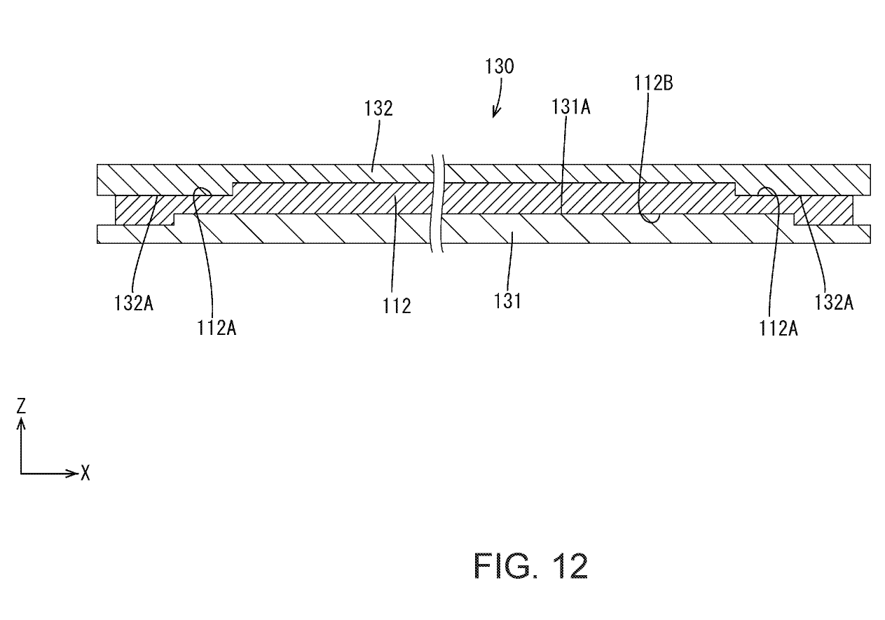

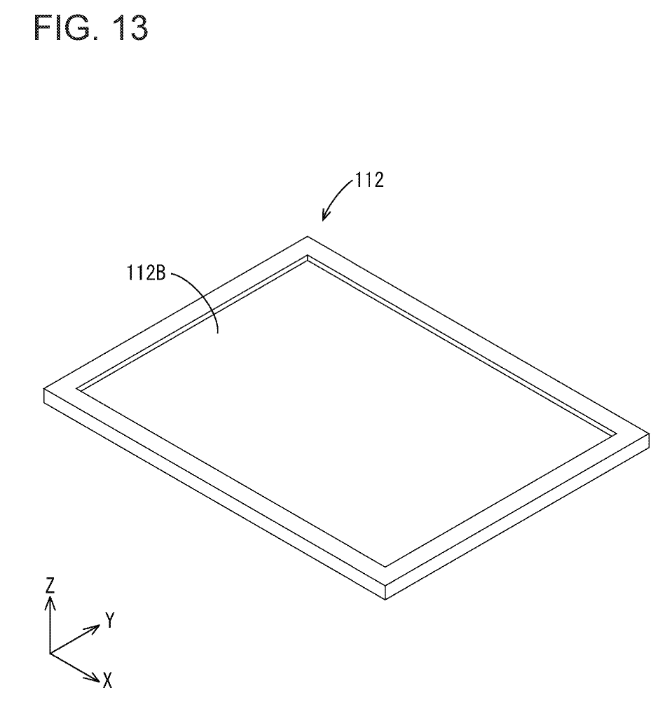

Next, the configuration of an adhesive member 130 for manufacturing the bonded member 110 described above will be explained. Only the parts of the adhesive member 130 that differ from Embodiment 1 will be explained. As shown in FIG. 12, in the adhesive member 130 of the present embodiment, the second recess 112B described above is provided in the adhesive layer 112. As described above, this second recess 112B is the same shape as the polarizing plate 114D attached to the adhesive layer 112, and as shown in FIG. 13, the second recess is recessed on the back surface of the adhesive layer 112 except at the periphery (the frame-shaped area). As shown in FIG. 12, in the adhesive member 130, of a pair of protective sheets 131 and 132, the protective sheet 132 positioned on the back side with the adhesive layer 112 interposed therebetween has a second temporary attachment-side protrusion 131A that protrudes towards the front (towards the adhesive layer 112) at a location on the front surface (one example of a temporarily attached surface) of the protective sheet 132 attached to the second recess 112B in the adhesive layer 112. This second temporary attachment-side protrusion 131A is the same shape as the polarizing plate 114D positioned on the front side of the liquid crystal panel 114 and has the same height dimensions as the polarizing plate 114D.

In a similar manner to Embodiment 1, a method of manufacturing the adhesive member 130 configured in this manner starts with preparing a pair of flexible sheet-shaped pre-processed protective sheets each having both surfaces flat. Then, a temporary attachment-side protrusion 132A is formed on one of the pre-processed protective sheets (the sheet that will be positioned on the front side of the adhesive layer 112), and the second temporary attachment-side protrusion 131A described above is formed on the other pre-processed protective sheet (the sheet that will be positioned on the back side of the adhesive layer 112). The method of forming the temporary attachment-side protrusion 132A and the second temporary attachment-side protrusion 131A on the respective pre-processed protective sheets is not limited to Embodiment 1. Moreover, the respective protective sheets may alternatively be prepared already having the temporary attachment-side protrusion 134A and second temporary attachment-side protrusion 131A formed respectively thereon. The above fabricates the pair of protective sheets 131 and 132 forming a portion of the adhesive member 130 (one example of a temporary attachment member fabrication step).

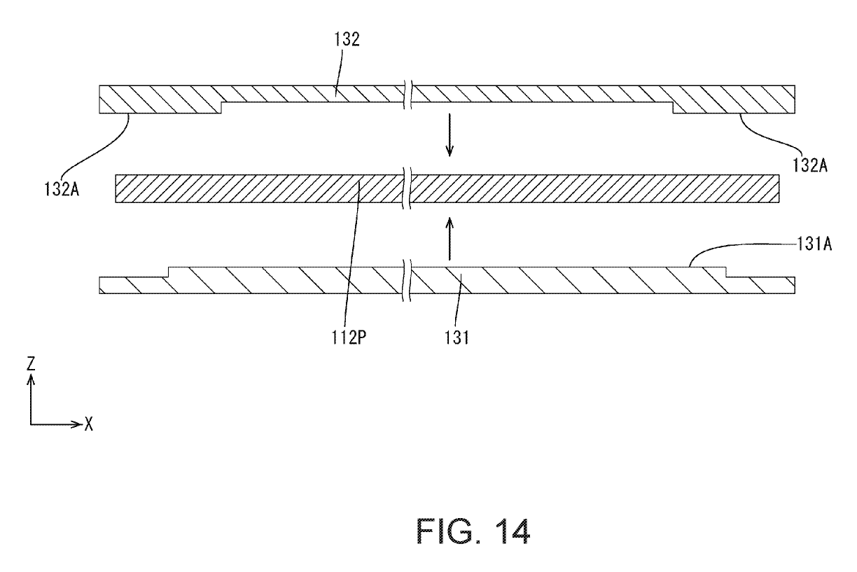

Thereafter, in a similar manner to Embodiment 1, a pre-photocured adhesive 112P having flat surfaces to which the pair of protective sheets 131 and 132 attach is prepared. Then, as shown in FIG. 14, while the temporary attachment-side protrusion 132A and the second temporary attachment-side protrusion 131A of the respective protective sheets face inward (face the adhesive agent 112P), the adhesive agent 112P is arranged between the pair of protective sheets 131 and 132 and pressure is applied while this adhesive agent 112P is interposed between the pair of protective sheets 131 and 132. This transcribes the temporary attachment-side protrusion 132A onto the location of the adhesive agent 112P facing the temporary attachment-side protrusion 132A and forms a recess 112A, and transcribes the second temporary attachment-side protrusion 131A onto the location of the adhesive agent 112P facing the second attachment protrusion 131A to form the second recess 112B. Furthermore, applying pressure with the adhesive agent 112P interposed between the pair of protective sheets 131 and 132 temporarily attaches the respective protective sheets 131 and 132 to the adhesive agent 112P. Thereafter, the adhesive agent 112P is photocured and the adhesive layer 112, which constitutes a portion of the adhesive member 130, is formed while maintaining the shape and depth dimensions of the recess 112A and the second recess 112B in the adhesive agent 112P (one example of an adhesive layer formation step). The above process completes the adhesive member 130 shown in FIG. 12.

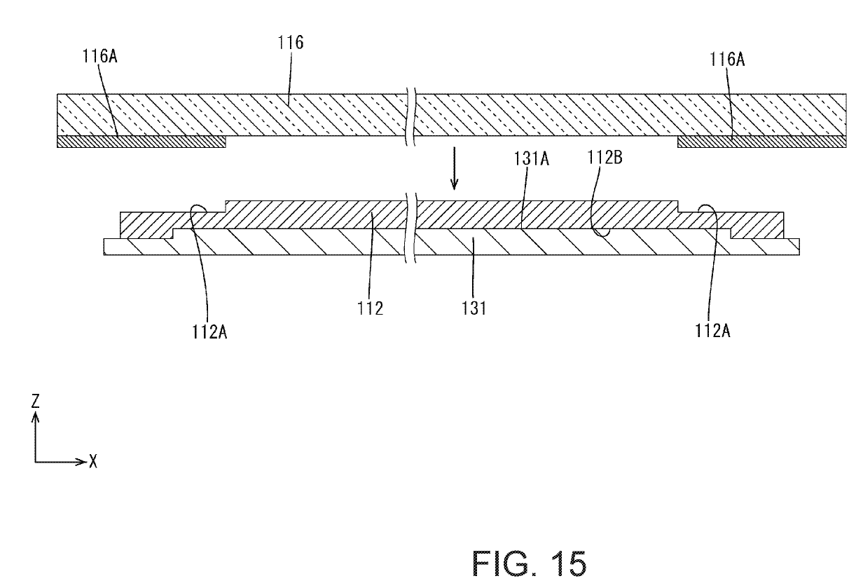

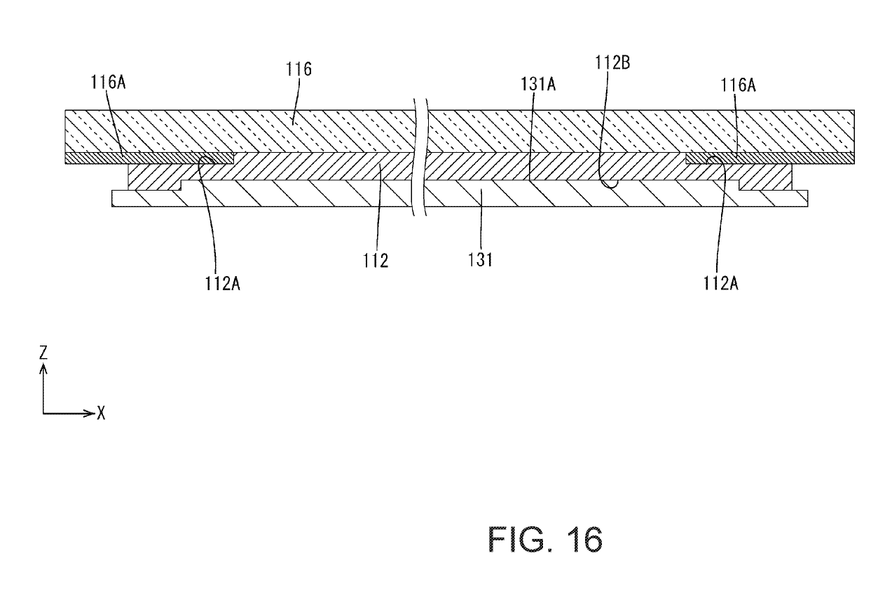

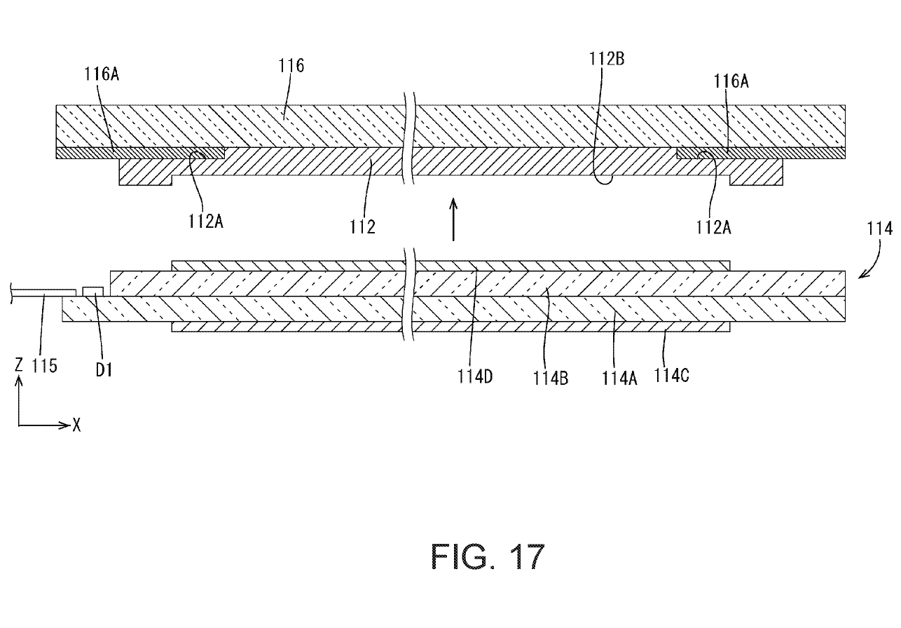

Next, a method of manufacturing the bonded member 10 described above using this adhesive member 130 will be explained. The series of steps in which the adhesive member 130 is prepared, one protective sheet 132 is removed from the front surface of the adhesive layer 112, the adhesive layer 112 and the protective panel 116 are positioned relative to one another, and then the protective panel 116 is attached to the removal surface of the adhesive layer 112, is the same as in Embodiment 1, and thus an explanation thereof will be omitted (see FIGS. 15 and 16). Thereafter, the other protective sheet 131 (the sheet having the second temporary attachment-side protrusion 131A formed thereon) is removed from the back surface of the adhesive layer 112 (one example of a removing step). As shown in FIG. 17, this exposes the second recess 112B where the second temporary attachment-side protrusion 131A was transcribed at the rear surface of the adhesive layer 112 from which the other protective sheet 131 has been removed. Next, as shown in FIG. 17, the adhesive layer 112 from which the other protective sheet 131 has been removed and the liquid crystal panel 114 are positioned along the removal surface, or namely, the X-Y planar direction (one example of a positioning step). Specifically, while the polarizing plate 114D positioned on the front side of the liquid crystal panel 114 is facing the removal surface of the adhesive layer 112, the adhesive layer 112 from which the other protective sheet 131 was removed is positioned relative to the liquid crystal panel 114 along the removal surface such that the polarizing plate 114D and the second recess 112B face each other (see FIG. 17). This causes the polarizing plate 114D and the second recess 112B to overlap in a plan view.

Next, the positioned liquid crystal panel 114 and adhesive layer 112 from which the other protective sheet 131 has been removed are bonded together (one example of a bonding step). Specifically, the liquid crystal panel 114 and the adhesive layer 112 are bonded together such that the polarizing plate 114D positioned on the front side of the liquid crystal panel 114 fits into the second recess 112B in the adhesive layer 112. This positioning causes the polarizing plate 114D and the second recess 112B to overlap in a plan view as described above, and thus it is possible to bond the liquid crystal panel 114 and the adhesive layer 112 together by the polarizing plate 114D fitting into the second recess 112B in this manner. This makes it possible to attach the liquid crystal panel 114 to the removal surface of the adhesive layer 112 in a way that conforms the polarizing plate 114D. In other words, the step surface of the step formed by the polarizing plate 114D abutting the step surface of the step formed by the second recess 112B allows the front surface of the liquid crystal panel 114 on which the polarizing plate 114D is formed to be attached to the back surface of the adhesive layer 112 with no gaps therebetween. The above process completes the bonded member 110 shown in FIG. 10.

In the embodiment described above, the bonded member 110 is manufactured using the adhesive member 130, which includes the adhesive layer 112 with the recess 112A and second recess 112B formed therein, and this makes it possible for the protective panel 116 to be attached to the front surface of the adhesive layer 112 by conforming to the window frame portion 116A of the protective panel 116, and also makes it possible for the liquid crystal panel 114 to be attached to the back surface of the adhesive layer 112 by conforming to the polarizing plate 114D positioned on the front side of the liquid crystal panel 114. Due to this, for the protective panel 116 having the window frame portion 116A, it is possible to inhibit the intrusion of air bubbles into the space between the protective panel 116 and the adhesive layer 112. Furthermore, it is possible to inhibit the intrusion of air bubbles into the space between the liquid crystal panel 114 and the back surface of the adhesive layer 112 for a liquid crystal panel 114 that has a polarizing plate 114D positioned on the front side of the liquid crystal panel 114 and attached to the adhesive layer 112 while being covered by the adhesive layer 112, as in the present embodiment. In this manner, it is possible to achieve favorable display quality in a liquid crystal display device including the bonded member 110 described above due to the intrusion of air bubbles being inhibited in the space between the protective panel 116 and the front surface of the adhesive layer 112 and the space between the liquid crystal panel 114 and the back surface of the adhesive layer 112.

Furthermore, in the present embodiment, the polarizing plate 114D positioned on the front side of the liquid crystal panel 114 has the entire surface thereof except for the surface attached to a CF substrate 114B of the liquid crystal panel 114 covered by the adhesive layer 112, and the front surface of the liquid crystal panel 114 where the polarizing plate 114D is positioned is attached to the back surface of the adhesive layer 112 with no gaps therebetween. Thus, it is possible to prevent or inhibit degradation in display quality of the liquid crystal display device caused by moisture being absorbed by the end faces of the polarizing plate 114D.

### Embodiment 3

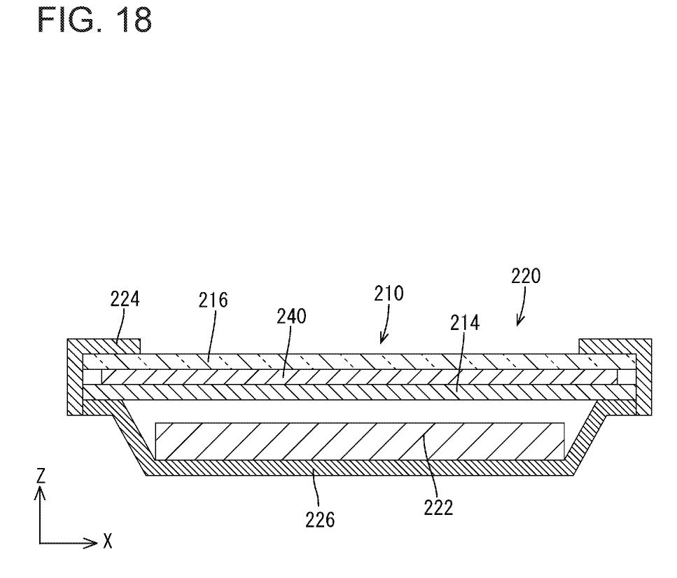

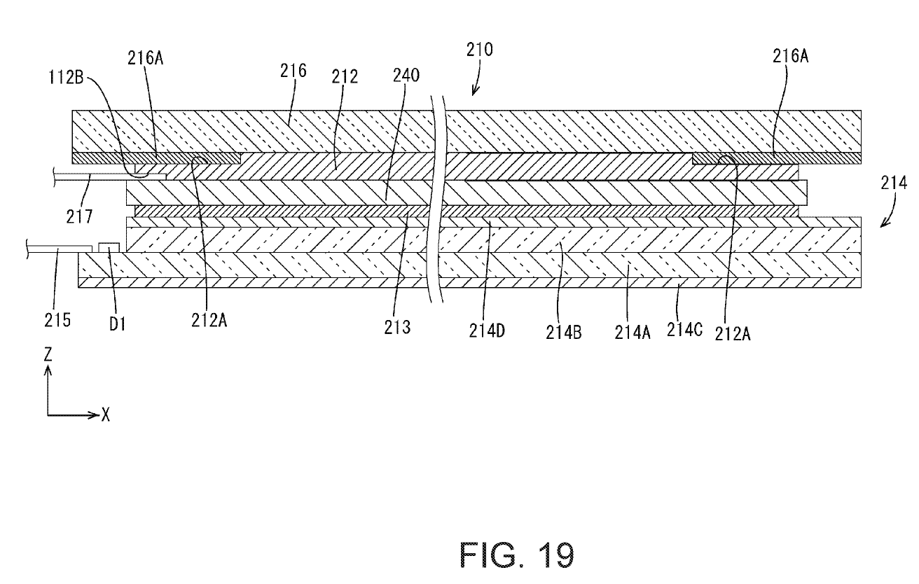

Embodiment 3 will be described with reference to FIGS. 18 to 22. As illustratively shown in FIG. 19, a bonded member 210 of Embodiment 3 includes a touch panel (one example of a bonding object) 240 bonded via an adhesive layer 212 to a protective panel (one example of a bonding object) 216 that protects the display surface side (front side) of this touch panel 240, and a liquid crystal panel 214 is bonded to the back side of the touch panel 240 with a second adhesive layer 213 interposed therebetween, thus forming a portion of a liquid crystal display device 220 shown in FIG. 18. The second adhesive layer 213 is a transparent photocurable adhesive agent that is sheet-shaped with both the front and back surface being flat and adhesive. The configuration of the liquid crystal display device 220 except for the liquid crystal panel 214, protective panel 216, and bonded member 210 is the same as Embodiment 1, and thus an explanation thereof will be omitted. Parts in FIGS. 18, 19, and 21 that have 200 added to the reference characters of FIGS. 1, 2, and 4 are the same as those parts described in Embodiment 1.

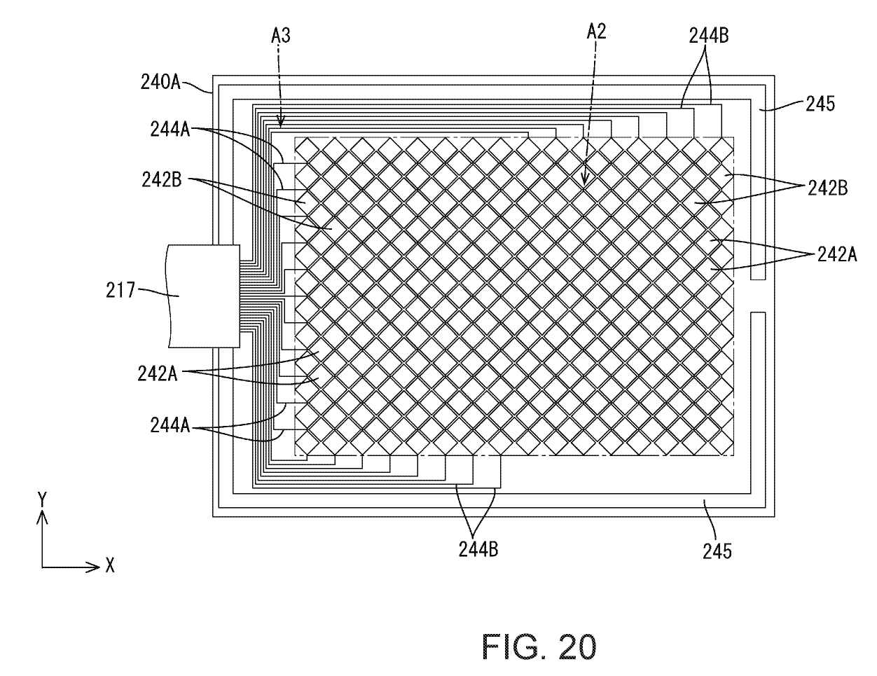

First, a configuration of the touch panel 240 will be described. As shown in FIG. 20, the touch panel 240 includes a transparent glass substrate 240A that is a rectangular shape in a plan view. As shown in FIG. 20, the touch panel 240 includes a first overlapping area A2 that overlaps the display area of the liquid crystal panel 214 in a plan view and a second overlapping area A3 that overlaps the non-display area (the area outside the display area) of the liquid crystal panel in a plan view, with the second overlapping area A3 having a substantial frame shape that surrounds the first overlapping area A2. The touch panel 240 is slightly smaller than the protective panel 216 and liquid crystal panel 214 and is bonded to the liquid crystal panel 214 by the second adhesive layer 213 in parallel to the liquid crystal panel 214.

As shown in FIG. 20, first transmissive electrodes 242A and second transmissive electrodes 242B are formed on the front surface of the glass substrate 240A (the surface facing the protective panel 216), which forms a portion of the touch panel 240. The first transmissive electrodes 242A extend in a plurality of columns along the lengthwise (X-axis direction) of the touch panel 240, and the second transmissive electrodes 242B extend in a plurality of columns along the widthwise (Y-axis direction) of the touch panel 24. Both of the transmissive electrodes 242A and 242B are made of transmissive conductive materials that are almost transparent, such as ITO (indium tin oxide), and are arranged in the first overlapping area A2 on the touch panel 240. Furthermore, both of the transmissive electrodes 242A and 242B are constituted by a plurality of pads that are diamond-shaped in a plan view, and connectors that connect adjacent pads together. An insulating film is interposed between the transmissive electrodes 242A and 242B, and the first transmissive electrodes 242A and the second transmissive electrodes 242B are stacked in this order on the outer surface of the glass substrate 240A. The touch panel 240 of the present embodiment is a so-called projected capacitance scheme having a one-side stacked structure in which both of the transmissive electrodes 242A and 242B are stacked on the glass substrate 240A, and the change in surface charge at the touched location in the electric field formed by the transmissive electrodes 242A and 242B is ascertained in order to detect the location that was touched.

As shown in FIG. 20, the glass substrate 240A further includes thereon first potential-supplying wiring lines 244A for supplying a potential to the first transmissive electrodes 242A, second potential-supplying wiring lines 244B that supply a potential to the second transmissive electrodes 242B, and a ground wiring line 245 that can shield the transmissive electrodes 242A & 242B and the potential-supplying wiring lines 244A & 244B. Both of the potential-supplying wiring lines 244A & 244B and the ground wiring line 245 are made of a light-blocking metal material such as copper or titanium and are arranged in the second overlapping area A3 on the touch panel 240. Both of the potential-supplying wiring lines 244A & 244B and the ground wiring line 245 each have ends arranged on one end of the glass substrate 240 in the lengthwise direction and are connected to a second flexible substrate (one example of a protrusion) 217 arranged here, with the connection location serving as a terminal. As shown in FIG. 20, this second flexible substrate 217 is crimp connected to the glass substrate 240A via an anisotropic conductive film (not shown) at approximately the center of the glass substrate 240A in the widthwise direction. The second flexible substrate 217 has one end side thereof that connects to the various terminals of both potential-supplying wiring lines 244A & 244B and ground wiring line 245 via the anisotropic conductive film, whereas the other end sides connect to a controller substrate (not shown), which makes it possible for the potential supplied from the controller substrate to be transmitted to both potential-supplying wiring lines 244A & 244B and the ground wiring line 245.

In the touch panel 240, if the finger of the user, which is a conductor, approaches or contacts the display screen of the liquid crystal display device 220 while a voltage is being sequentially applied to the plurality of first transmissive electrode 242A columns and plurality of second transmissive electrode 242B columns, then the finger of the user will capacitively couple with one of the transmissive electrodes 242A and 242B, and the electrostatic capacitance value of this transmissive electrode 242A and 242B will differ from the electrostatic capacitance value of the other transmissive electrodes 242A and 242B. A coordinate plane is configured on the display screen, and in the touch panel 240 the transmissive electrodes 242A and 242B where a difference in electrostatic capacitance have occurred is detected. In the touch panel 240, the coordinates on the display screen conforming to the intersections of the transmissive electrodes 242A and 242B where a difference in electrostatic capacitance has been detected are converted into signals having two-dimensional (X-axis direction and Y-axis direction) location information related to the position on the display screen touched by the user, and these signals are output to the control substrate.

Next, the adhesive layer 212 forming a portion of the bonded member 210 will be described. The adhesive layer 212 forming a portion of the bonded member 210 is a transparent photocurable adhesive agent that is sheet-shaped with both the front and back surface being flat and adhesive. As shown in FIG. 19, the back surface of the adhesive layer 212 is attached to almost the entire front surface of the touch panel 240 including the second flexible substrate 217, and the front surface of the adhesive layer 212 is attached to almost the entire back surface of the protective panel 216 including a portion of a window frame portion 216A of the protective panel 216. The configuration of the front surface of the adhesive layer 212 is the same as the adhesive layer 12 of Embodiment 1, and thus an explanation thereof will be omitted.

As shown in FIG. 19, the back surface of the adhesive layer 212 is disposed so as to follow the shape and height dimensions (thickness dimensions) of the second flexible substrate 217. Accordingly, as shown in FIG. 19, a large portion of the surface of the second flexible substrate 217 crimp connected to the touch panel 240 is covered by the adhesive layer 112. Specifically, a third recess 212C is provided in a location on the rear surface of the adhesive layer 212 where a portion of the second flexible substrate 217 is attached. This third recess 212C is the same shape as the location of the second flexible substrate 217 attached to the adhesive layer 212, and the depth dimensions of this third recess are the same as the height dimensions of the second flexible substrate 217. Accordingly, in the bonded member 210 of the present embodiment, the touch panel 240 to which the second flexible substrate 217 is crimp connected is attached to the back surface of the adhesive layer 212 with the step surface of the step formed by the second flexible substrate 217 abutting the step surface of the step formed by the third recess 212C.

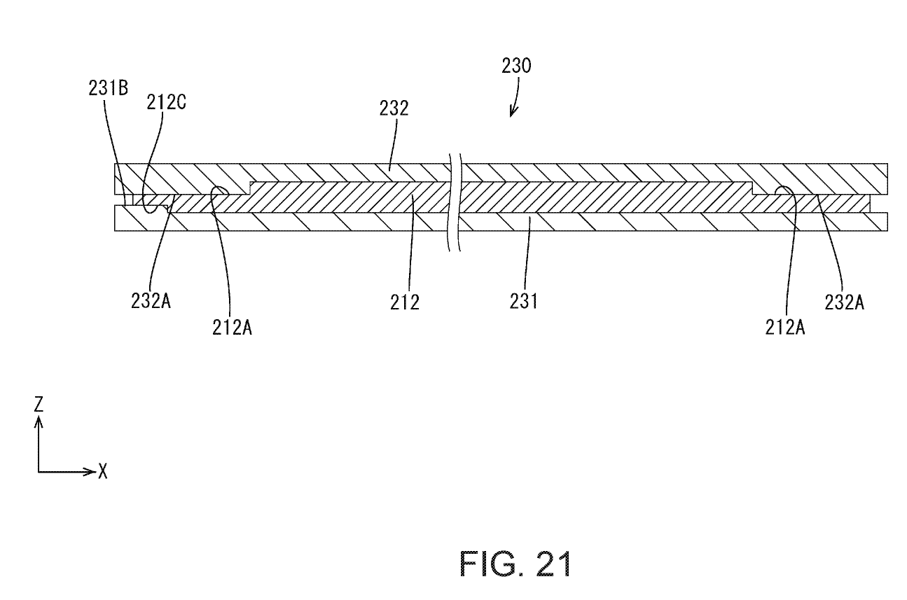

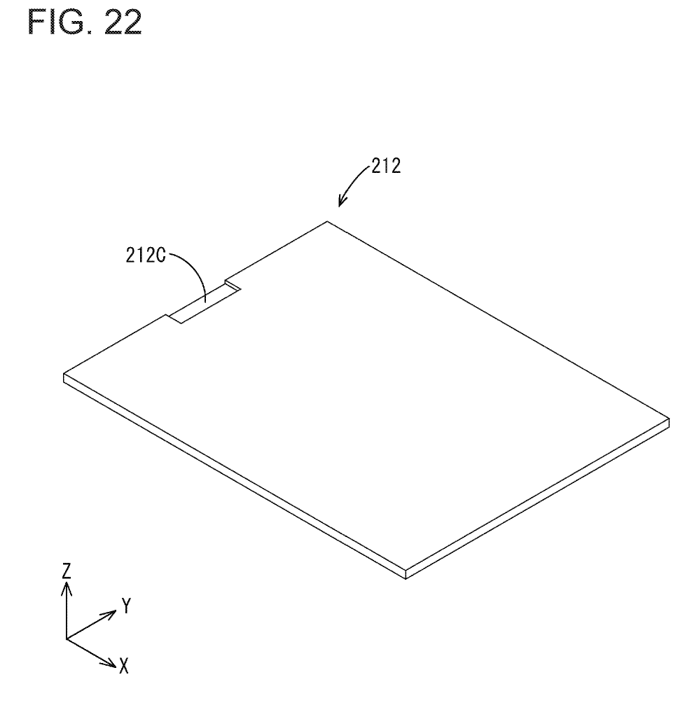

Next, the configuration of an adhesive member 230 for manufacturing the bonded member 210 described above will be explained. Only the parts of the adhesive member 230 that differ from Embodiment 1 will be explained. As shown in FIG. 21, in the adhesive member 230 of the present embodiment, the third recess 212C described above is provided in the adhesive layer 212. As described above, the third recess 212C is the same shape as the location of the second flexible substrate 217 attached to the adhesive layer 212, and as shown in FIG. 22, the location on the back surface of the adhesive layer 212 where the portion of the second flexible substrate 217 is attached is recessed. As shown in FIG. 21, in the adhesive member 230, of a pair of protective sheets 231 and 232, the protective sheet 232 positioned on the back side with the adhesive layer 212 interposed therebetween has a third temporary attachment-side protrusion 231B that protrudes towards the front (towards the adhesive layer 212) at a location on the front surface (one example of a temporarily attached surface) of the protective sheet 232 attached to the third recess 212B in the adhesive layer 212. The third temporary attachment-side protrusion 231B is the same shape as the location of the second flexible substrate 217 crimp connected to the touch panel 240, and the height dimensions of the third temporary attachment-side protrusion are the same as the height dimensions of the second flexible substrate 217.

In a similar manner to Embodiment 1 and Embodiment 2, a method of manufacturing the adhesive member 230 configured in this manner starts with preparing a pair of flexible sheet-shaped pre-processed protective sheets each having both surfaces flat. Then, a temporary attachment-side protrusion 232A is formed on one of the pre-processed protective sheets (the sheet that will be positioned on the front side of the adhesive layer 212), and the third temporary attachment-side protrusion 231B described above is formed on the other pre-processed protective sheet (the sheet that will be positioned on the back side of the adhesive layer 212), thus fabricating the pair of protective sheets 231 and 232 that form a portion of the adhesive member 230 (one example of a temporary attachment member fabrication step).

Thereafter, in a similar manner to Embodiment 1, a pre-photocured adhesive agent having flat surfaces to which the pair of protectives sheets 231 and 232 attach is prepared, and the adhesive agent is disposed between the pair of protective sheets 231 and 232 while the temporary attachment-side protrusion 132A and third temporary attachment-side protrusion 231B of the respective protective sheets 231 and 232 are facing inwards (facing towards the adhesive agent, and then pressure is applied to this adhesive agent via the pair of protective sheets 231 and 232 sandwiching the adhesive agent. In a similar manner to Embodiment 1 and Embodiment 2, this transcribes the temporary attachment-side protrusion 232A onto the location of the adhesive agent facing the temporary attachment-side protrusion 232A and forms a recess 212A, and transcribes the third temporary attachment-side protrusion 231B onto the location of the adhesive agent facing the third attachment protrusion 231B to form the third recess 212C. Thereafter, the adhesive agent is photocured and the adhesive layer 212, which constitutes a portion of the adhesive member 230, is formed while maintaining the shape and depth dimensions of the recess 212A and the third recess 212C in the adhesive agent (one example of an adhesive layer formation step). The above process completes the adhesive member 230 shown in FIG. 21.

Next, a method of manufacturing the bonded member 210 described above using this adhesive member 230 will be briefly described. In the present embodiment, first the touch panel 240 and the liquid crystal panel 214 are bonded together with the second adhesive layer 213 interposed therebetween. In other words, the touch panel 240 is positioned relative to the second adhesive layer 213 along the X-Y planar direction, and the back surface of the touch panel 240, which is flat, is bonded to the front surface of the second adhesive layer 213, which is flat. Then, the liquid crystal panel 214 is positioned relative to the second adhesive layer 213 to which the touch panel 240 is attached along the X-Y planar direction, and the front surface of the liquid crystal panel 214, which is flat, is bonded to the back surface of the second adhesive layer 213, which is flat. The bonding of the touch panel 240 and the second adhesive layer 213 and the bonding of the liquid crystal panel 214 and the second adhesive layer 213 both involve the bonding of flat surfaces to one another, and thus the space between the touch panel 240 and the second adhesive layer 213 and the space between the liquid crystal panel 214 and the second adhesive layer 213 are not susceptible to warping, and the intrusion of air bubbles into these spaces is inhibited. The above completes a member in which the touch panel 240 and the liquid crystal panel 214 are bonded together with the second adhesive layer 213 therebetween.

Next, the adhesive member 230 is prepared, one protective sheet 232 is removed from the front surface of the adhesive layer 212, the adhesive layer 212 and the protective panel 216 are positioned relative to one another, and then the protective panel 216 is attached to the removal surface of the adhesive layer 212. This series of steps is the same as Embodiment 1. The steps thereafter are the same as Embodiment 2 but with the touch panel 240 instead of the liquid crystal panel 114. In other words, the other protective sheet 231 is removed from the back surface of the adhesive layer 212, and the adhesive layer 212 is positioned relative to the touch panel 240. Specifically, while the second flexible substrate 217 crimp connected to the touch panel 240 is facing the removal surface of the adhesive layer 212, the adhesive layer 212 from which the other protective sheet 231 has been removed is positioned relative to the touch panel 240 along the removal surface such that the location of the second flexible substrate 217 on the touch panel 240 faces the third recess 212C.

Thereafter, the positioned touch panel 240 is bonded to the adhesive layer 212 from which the other protective sheet 231 has been removed. Specifically, the touch panel 240 is bonded to the adhesive layer 212 with the location of the second flexible substrate 217 on the touch panel 240 fitting into the third recess 212C in the adhesive layer 212. This makes it possible to attach the touch panel 240 to the removal surface of the adhesive layer 212 so as to conform to the location of the second flexible substrate 217 on the touch panel 240. In other words, with the step surface of the step formed by the touch panel 240 abutting the step surface of the step formed by the third recess 212C, it is possible for the touch panel 240 to which the second flexible substrate 217 is crimp connected to the front side thereof to be attached to the back surface of the adhesive layer 212 with no gaps therebetween. The above process completes the bonded member 210 shown in FIG. 19.

In the embodiment described above, as in other embodiments, the bonded member 210 is manufactured using the adhesive member 230, which includes the adhesive layer 212 with the recess 212A and third recess 212C formed therein, and this makes it possible for the protective panel 216 to be attached to the front surface of the adhesive layer 212 by conforming to the window frame portion 216A of the protective panel 216, and also makes it possible for the touch panel 240 to be attached to the back surface of the adhesive layer 212 by conforming to the second flexible substrate 217 crimp connected to the front side of the touch panel 240. Due to this, for the protective panel 216 having the window frame portion 216A, it is possible to inhibit the intrusion of air bubbles into the space between the protective panel 216 and the adhesive layer 212. Moreover, for the touch panel 240 having the second flexible substrate 217 crimp connected to the front side thereof, it is possible to inhibit the intrusion of air bubbles into the space between the touch panel 240 and the back surface of the adhesive layer 212. Furthermore, as described above, it is also possible to inhibit the intrusion of air bubbles into the space between the touch panel 240 and the second adhesive layer 213, and the space between the touch panel 214 and the second adhesive layer 213. Inhibiting the intrusion of air bubbles into the space between the protective panel 216 and the adhesive layer 212, the space between the touch panel 240 and the adhesive layer 212, the space between the touch panel 240 and the second adhesive layer 213, and the space between the liquid crystal panel 214 and the second adhesive layer 213 in this manner makes it possible to achieve favorable display quality in a liquid crystal display device 220, which includes the bonded member 210 as described above.

Modification examples of the respective embodiments mentioned above are described below.

(1) In the respective embodiments above, a protective panel, liquid crystal panel, and touch panel were shown as examples of bonding object members, but the bonding object member is not limited to these. Furthermore, in the respective embodiments above, a window frame portion, polarizing plate, and second flexible substrate were shown as examples of protrusions, but the protrusion is not limited to these. The adhesive member of the present invention can be used to manufacture various bonded members that have a protrusion on a surface of the bonding object and where a pair of bonding objects are bonded together with an adhesive layer therebetween.

(2) In the respective embodiments above, an example was shown in which one bonding object had at most a single protrusion, but one bonding object may alternatively have two or more protrusions instead. In such a case, in the attachment member, a plurality of temporary attachment-side protrusions having the same shape and height dimensions as the respective protrusions formed on the bonding surface of the bonding object may be formed on the surface to which the temporary attachment members are temporarily attached, and the adhesive layer may be disposed between the pair of temporary attachment members so as to conform to the size and height dimensions of the respective temporary attachment-side protrusions on the temporary attachment members.

(3) In the respective embodiments above, an example was shown in which pressure was applied to the adhesive agent between the pair of protective sheets as an example of an adhesive layer formation step in the method of manufacturing the adhesive member, but a plurality of members having adhesive agents interposed therebetween may be prepared between the pair of protective sheets, and a plurality of adhesive layers may be formed at the same time by collectively applying pressure to this stack and then photocuring, for example.

(4) In the respective embodiments above, a transparent photocurable adhesive agent was shown as an example of the adhesive layer, but the adhesive layer is not limited to this. A transparent thermosetting adhesive agent may be used as the adhesive layer instead, for example.

(5) In the respective embodiments above, a protective sheet made of a PET film was shown as an example of the temporary attachment member, but the protective sheet is not limited to this as long as a person having ordinary skill in the art can remove the protective sheet from the adhesive layer.

(6) In the respective embodiments above, a liquid crystal display device including a liquid crystal panel and a backlight device was shown as one example of a device equipped with the bonded member, but the device equipped with the bonding member is not limited to this. Alternatively, the device may be a display device that causes images to be displayed on a display screen by using organic EL (electroluminescent) elements, or a display device that uses light emitted by electric discharge (plasma display), or a display device that causes images to be displayed on a display screen through a different method, for example.

In the respective embodiments above, a display device was shown as one example of a device equipped with the bonding member, but the device equipped with the bonding member is not limited to this, and the present invention is applicable to various bonded members used in contexts other than display devices.

The embodiments of the present invention were described above in detail, but these are only examples, and do not limit the scope as defined by the claims. The technical scope defined by the claims includes various modifications of the specific examples described above.

Description of Reference Characters

| | |
|---|---|
| 10, 110, 210 | bonding member |
| 12, 212, 312 | adhesive layer |
| 12A, 112A, 212A | recess |
| 12P, 112P | adhesive agent |
| 14, 114, 214 | liquid crystal panel |
| 14A, 114A, 214A | array substrate |
| 14B, 114B, 214B | CF substrate |
| 14C, 14D, 114C, 114D, | polarizing plate |
| 214C, 214D | |
| 15, 115, 215 | flexible substrate |
| 16, 116, 216 | protective panel |
| 16A, 116A, 216A | window frame portion |
| 20, 220 | liquid crystal display device |
| 22, 222 | backlight device |
| 30, 130, 230 | adhesive member |
| 31, 131, 231 | (one) protective sheet |
| 32, 131, 231 | (other) protective sheet |
| 32A, 132A, 232A | temporary attachment-side protrusion |
| 112B | second recess |
| 131A | second temporary attachment-side protrusion |
| 212C | third recess |
| 213 | second adhesive layer |
| 217 | second flexible substrate |
| 213B | third temporary attachment-side protrusion |
| 240 | touch panel |

1. An adhesive retainer for pre-shaping and retaining an adhesive layer for bonding a pair of objects together, at least one of the objects having a protrusion formed on a bonding surface thereof, the adhesive retainer comprising:
an adhesive layer; and
a pair of temporary attachment members temporarily and detachably attached to both respective surfaces of the adhesive layer,
wherein at least one of the pair of temporary attachment members has, on a surface thereof that is temporarily attached to the adhesive layer, a temporary attachment-side protrusion having a same shape and height as the protrusion formed on the bonding surface of said at least one of the objects, and
wherein the adhesive layer is disposed between the pair of temporary attachment members so as to conform to the shape and height of the temporary attachment-side protrusion of said at least one of the pair of temporary attachment members.

2. The adhesive retainer according to claim 1, wherein the adhesive layer is disposed between the pair of temporary attachment members with no space between the adhesive layer and the pair of temporary attachment members.

3. The adhesive retainer according to claim 1, wherein each of the pair of attachment members is a flexible sheet shape.

4. A method of manufacturing an adhesive member retainer for pre-shaping and retaining an adhesive layer for bonding a pair of objects together, at least one of the objects having a protrusion formed on a bonding surface thereof, the method comprising:
a temporary attachment member fabrication step of fabricating a pair of temporary attachment members, at least one of the pair of temporary attachment members having, on a surface thereof, a temporary attachment-side protrusion having a same shape and height as the protrusion formed on the bonding surface of said at least one of the objects; and
an adhesive layer formation step including:
disposing an adhesive agent between the pair of temporary attachment members with the temporary attachment-side protrusion facing inward; and
pressing the pair of temporary attachment members together with the adhesive agent therebetween so as to transcribe the temporary attachment-side protrusion in the adhesive agent to form a corresponding recess, thereby forming an adhesive layer to which the pair of temporary attachment members are temporarily and detachably attached.

5. A method for bonding a pair of objects together by using an adhesive retainer for pre-shaping and retaining an adhesive layer, at least one of the objects having a protrusion formed on a bonding surface thereof, the adhesive retainer including an adhesive layer and a pair of temporary attachment members temporarily and detachably attached to respective surfaces of the adhesive layer, at least one of the pair of temporary attachment members having, on a surface thereof temporarily attached to the adhesive layer, a temporary attachment-side protrusion having a same shape and height as the protrusion formed on the bonding surface of said at least one of the objects, thereby creating a corresponding recess in the adhesive layer, the method comprising:
a removing step of removing one of the temporary attachment members having the temporary attachment-side protrusion from the adhesive layer;
a positioning step of positioning a surface of the adhesive layer from which said one of the temporary attachment members has been removed relative to the bonding surface of one of the objects having said protrusion; and
a bonding step of pressing together the adhesive layer that has been positioned and said one of the objects so as to bond together said one of the objects and said adhesive layer from which said one of the temporary attachment members has been removed,
wherein, in the positioning step, the object is positioned relative to the adhesive layer from which said one of the attachment members has been removed such that the protrusion on the object faces the recess formed in the surface of the adhesive layer from which said one of the temporary attachment members has been removed, and
wherein, in the bonding step, the object is bonded to the adhesive layer with the protrusion on the object fitting into the recess.

6. The method according to claim 5, further comprising, after the bonding step or before the removing step:
removing another of the temporary attachment members from the adhesive layer;
positioning the surface of the adhesive layer from which said another of the temporary attachment members has been removed relative to another of the objects; and
pressing the adhesive layer that has been positioned to said another of the objects so as to bond together said another of the objects and said adhesive layer from which said another of the temporary attachment members has been removed.
